(19) United States
(12) Patent Application Publication
(10) Pub. No.: US 2017/0326782 A1
(43) Pub. Date: Nov. 16, 2017

(54) Vehicle Safety Plastic Mold Tools and Methods Of Use for Localized Stiffness Reduction

(71) Applicant: Toyota Motor Engineering & Manufacturing North America, Inc., Erlanger, KY (US)

(72) Inventor: Jaime N. Moore, Ann Arbor, MI (US)

(73) Assignee: Toyota Motor Engineering & Manufacturing North America, Inc., Erlanger, KY (US)

(21) Appl. No.: 15/152,043

(22) Filed: May 11, 2016

(51) Int. Cl. B29C 51/26; B29C 51/32; B29C 51/18; B29C 51/10; B29K 101/12; B29K 105/00; B29L 31/30

(52) U.S. Cl. CPC B29C 51/265; B29C 51/18; B29C 51/32; B29C 51/10; B29K 2105/256; B29L 2031/3041; B29K 2101/12

(57) ABSTRACT

Methods and systems for vacuum forming to form a final plastic product defining a notch, including providing a plastic material; providing a mold for a preform plastic product from which to form the final plastic product having a sacrificial forming feature associated with forming an inline trimmable part defining a notch area from which to form the notch, the sacrificial forming feature positioned on the mold within the notch area to be trimmed via an inline trimming operation to form the notch and shaped to selectively reduce a material thickness at a selective remaining location of the preform plastic product; disposing the plastic material on the mold to form an assembly; applying vacuum forming to the assembly to form the preform plastic product; and reducing the material thickness at the selective remaining location of the preform plastic product during vacuum forming to affect a corresponding localized stiffness reduction.

### TECHNICAL FIELD

The present specification generally relates to mold tools to form automotive vehicle parts from safety plastics and, more specifically, to mold tools to form automotive vehicle impact absorption plates from energy absorption (EA) safety plastics and methods of use of such tools with vacuum forming operations for localized stiffness reduction through material thickness reduction at selective locations of a preform plastic product from which a final plastic product is formed.

### BACKGROUND

Manufacturers may wish to remove parts from a preform plastic product created with use of a first mold during a vacuum forming process to form a final plastic product. For example, manufacturers may wish to remove molded features from a vehicle impact absorption plate, which molded features and plate are formed from a vacuum forming process that is applied to a first input plastic material of a restricted thickness to shape the material with use of the first mold. However, such operations may require the use of an additional processing step of offline trimming at a location separate from a location inline with the vacuum forming operation, which adds additional time and expense in creating the final plastic product.

Accordingly, a need exists for alternative mold tools and inline trimming processes to remove parts from a preform plastic product formed with a redesigned mold, while utilizing the restricted thickness of the first input plastic material, and methods of use of such mold tools.

### SUMMARY

In one embodiment, a method for vacuum forming to form a final plastic product that has a notch disposed between and inward of outermost perimeter ends of the final plastic product may include providing a first input plastic material and providing a mold for a preform plastic product from which to form the final plastic product. The mold may have a sacrificial forming feature associated with forming an inline trimmable part of the preform plastic product, the inline trimmable part defining a notch area from which to form the notch of the final plastic product, the sacrificial forming feature positioned on the mold to be disposed within the notch area. The notch area of the inline trimmable part may be configured to be trimmed via an inline trimming operation to form the notch. The sacrificial forming feature may be shaped to selectively reduce a material thickness at a selective remaining location of the preform plastic product. The method may further include disposing the first input plastic material on the mold to form an assembly, applying vacuum forming to the assembly to form the preform plastic product, and reducing the material thickness the selective remaining location of the preform plastic product during vacuum forming to affect a localized stiffness reduction at a corresponding selective remaining location of the final plastic product.

In another embodiment, a mold for vacuum forming to form a final plastic product that has a notch disposed between and inward of outermost perimeter ends of the final plastic product may include a sacrificial forming feature associated with forming an inline trimmable part of a preform plastic product from which to form the final plastic product, the inline trimmable part defining a notch area from which to form the notch of the final plastic product, the sacrificial forming feature positioned on the mold to be disposed within the notch area. The notch area of the inline trimmable part is configured to be trimmed via an inline trimming operation to form the notch. The sacrificial forming feature may be shaped to selectively reduce a material thickness at a selective remaining location of the preform plastic product that is configured to form a corresponding selective remaining location of the final plastic product.

In yet another embodiment, a system for vacuum forming to form a preform plastic product from which to form a final plastic product that has a notch disposed between and inward of outermost perimeter ends of the final plastic product may include a processor communicatively coupled to a non-transitory computer storage medium. The non-transitory computer storage medium stores instructions that, when executed by the processor, cause the processor to heat a first input plastic material to an optimal vacuum forming temperature such that the first input plastic material becomes pliable and automatically position the pliable first input plastic material on a mold for the final plastic product to form an assembly. The mold may include a sacrificial forming feature associated with forming an inline trimmable part of the preform plastic product, the inline trimmable part defining a notch area from which to form the notch of the final plastic product, the sacrificial forming feature positioned on the mold to be disposed within the notch area. The notch area of the inline trimmable part may be configured to be trimmed via an inline trimming operation to form the notch. The sacrificial forming feature is shaped to selectively reduce a material thickness at a selective remaining location of the preform plastic product. The non-transitory computer storage medium may store further instructions that, when executed by the processor, cause the processor to apply a vacuum forming process to the assembly to form the preform plastic product such that the material thickness at the selective remaining location of the preform plastic product is reduced during vacuum forming to affect a localized stiffness reduction at a corresponding selective remaining location of the final plastic product.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1A illustrates an example final plastic product including a set of three molded features at an upper portion, according to one or more embodiments shown and described herein;

FIG. 1B schematically illustrates a first mold used to form the example final plastic product of FIG. 1A, according to one or more embodiments shown and described herein;

FIG. 2A illustrates an example final plastic product including a single remaining molded feature and a removed portion previously including space for a pair of molded features at an upper portion, according to one or more embodiments shown and described herein;

FIG. 2B schematically illustrates the first mold of FIG. 1A used to form the first final plastic product of FIG. 2A and illustrating an offline trimming area associated with a pair of molded features from FIG. 1A that are removed via an offline trimming operation, according to one or more embodiments shown and described herein;

FIG. 2C schematically illustrates a second mold similar to the first mold of FIG. 1A, and redesigned to mold a single molded feature at the upper portion of the example final plastic product, the redesigned mold being used to form the first final plastic product of FIG. 2A having a greater material thickness in molded feature A than that of molded feature A of FIG. 1A, according to one or more embodiments shown and described herein;

FIG. 3A illustrates an example preform plastic product and formed final plastic product including a single remaining molded feature and a removed portion previously including space for one or more molded features formed from sacrificial forming features of a mold at an upper portion, according to one or more embodiments shown and described herein;

FIG. 3B schematically illustrates a third mold including sacrificial forming features to form shapes to be removed by an inline trimming operation and used to form the example final plastic product of FIG. 3A, which may have approximately the same material thickness in molded feature A as that of molded feature A of FIG. 1A, according to one or more embodiments shown and described herein;

FIG. 4 is a flow chart of a vacuum forming process utilizing the third mold of FIG. 3B to form the example final plastic product of FIG. 3A, according to one or more embodiments shown and described herein; and

FIG. 5 schematically illustrates a system for implementing computer and software based methods to apply a vacuum forming process with vacuum forming machinery, according to one or more embodiments shown and described herein.

### DETAILED DESCRIPTION

Referring generally to the figures, embodiments of the present disclosure are directed to mold tools and vacuum forming methods utilizing the mold tools described herein. The mold tools include, for example, a mold having one or more sacrificial forming features associated with a notch area of a preform plastic product to be trimmed via an inline trimming operation and shaped to selectively reduce material thickness at one or more remaining portions to form a final plastic product. Further, the sacrificial forming features are spaced a sufficient minimum distance from a trimline to permit the inline trimming operation. Moreover, the sacrificial forming features, which are shaped to reduce material thickness of one or more remaining molded features of the final plastic product, also affect a stiffness reduction at the one or more remaining molded features to selectively weaken an area of a part and affect part performance. Thus, the mold tools described herein may change the design for a final plastic product to affect part performance while working within a parameter set by a restricted thickness of a first input plastic material. Various embodiments of mold tools designed for localized stiffness reduction in vacuum forming processes and methods of use for such mold tools are described in detail herein.

A vacuum forming process (also referable to as vacuum thermoforming) generally utilizes a flat sheet of safety plastic, such as an energy absorption (EA) plastic, and applies heat to the EA plastic followed by applying vacuum pressure to pull the EA plastic over or into a mold. For example, with such a plastic manufacturing process, a two-dimensional sheet of EA plastic is heated to a optimal forming temperature such that the EA plastic is pliable and moldable. The pliable EA plastic is then subjected to vacuum suction and pressure against the mold to form a three dimensional shape corresponding to the mold shape. Thus, in such a manner, the EA plastic is formed into the shape of the mold. The mold may be made of metals such as steel, for example, and/or other like materials suitable for mold formation and able to withstand the high temperatures of the vacuum forming process. Further, the mold may be shaped by Computer Numerical Control (“CNC”) machining.

Usable plastics may include thermoplastic polymers that become pliable above and a certain temperature and solidify upon cooling, such as polypropylene (“PP”), poly(methyl methacrylate) (“PMMA”), Acrylonitrile butadiene styrene (“ABS”), Polycarbonate (“PC”), Polyethylene (“PE”), Polyphenylene oxide (“PPO”), Polystyrene, and other like plastics. The shaped EA plastic may be subject to an inline and/or offline trimming process to further form a desired shape for the final plastic product to be formed.

The final plastic product may be, for example, a vehicle impact absorption sheet made of EA plastic. The vehicle impact absorption sheet may be placed as a headliner adhered to an inside vehicle roof and configured to absorb energy from any impact of a head of a vehicle passenger or driver when the vehicle is involved in an impact. Additionally or alternatively, the vehicle impact absorption sheet (or plate) may be positioned within and/or against doors of the vehicle during vehicle manufacture.

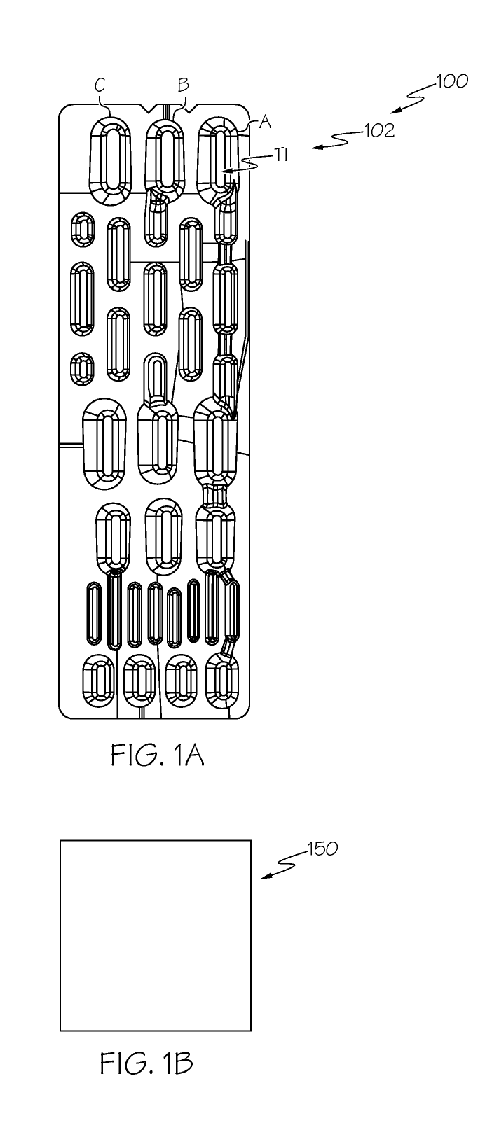

In embodiments, for example, a vacuum formed final plastic product 100 may have an area 102 including three formed molded features A, B, and C, as projections shown in FIG. 1A. All three of the molded features A, B, and C are formed to be part of a preform plastic product that is trimmed with an inline trimming process to result in the final plastic product 100. The inline trimming process may include, for example, utilizing a die cutting board that is similarly shaped to the mold to cut out predetermined individual pieces to be discarded as scrap. Inline trimming as described herein discloses a trimming operation that trims a preform plastic part at a location inline with a vacuum forming location (e.g., at or along the same online assembly line) prior to applying the trimming, such as through use of the die cutting board. Offline trimming, by contrast, removes the preform plastic part to a separate location for an offline trimming, such as by, for example, a laser trim operation.

A mold 150, as schematically shown in FIG. 1B, may be used with a first input plastic material to form a preform plastic product, from which to form the final plastic product 100, through a vacuum forming process as described herein. The first input plastic material may have a thickness in the range of from about 1 mm to about 3 mm. For example, the first input plastic material may have a thickness of about 1.3 mm or of about 2.4 mm. Each of the molded features A, B, and C will have a formed thickness through the process. For example, molded feature A may have a thickness T1.

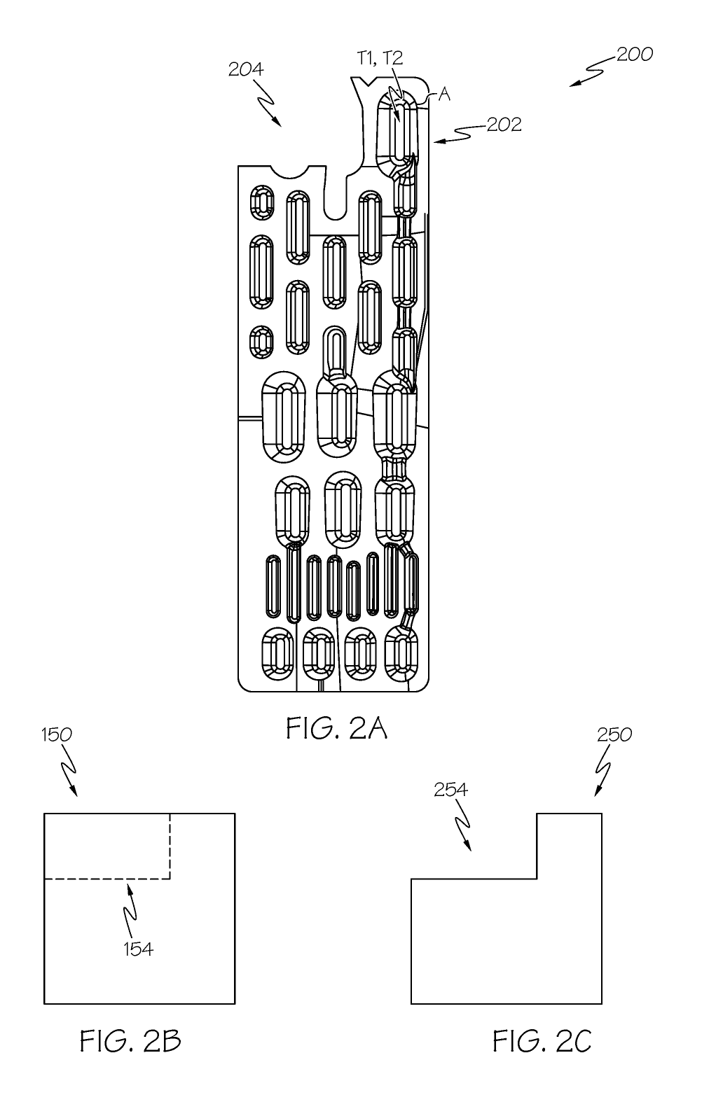

FIG. 2A shows another mold design with molded features removed from an area 204 to affect part performance. The removed molded features may be, for example, the two molded features B and C, resulting in a single molded feature A remaining in an area 202 of a final plastic product 200. For example, the removal may occur through a secondary offline trimming operation such as a laser trim process to remove desired shapes and areas of the vacuumed formed material to create the desired final plastic product 200. The secondary offline trimming operation adds an additional expense to the total operation as an extra processing step as the preform plastic product is moved to an offline location prior to trimming. If such a secondary offline trimming operation is employed, the mold 150 of FIGS. 1B and 2B may be used. FIG. 2B schematically indicates a trim association area 154 indicating an area that forms the two molded features to be trimmed to form the final plastic product 200. With use of such an operation and the mold 150, remaining molded feature A may still have a thickness T1, similar to the thickness T1 of molded feature A in FIG. 1A.

As the offline trimming operation adds an extra expense, however, a process that utilizes the inline trimming operation may be desired to remove the two molded feature s B and C from the final plastic product 200 by a redesign of the utilized mold. One mold redesign, as shown schematically by a mold 250 of FIG. 2C, would remove the two molded features B and C from the mold. By just removing the two molded features B and C from an area 254 of the mold 250 that is associated with the area 204 of FIG. 2A previously containing molded features B and C, however, the stretch of the plastic material over the remaining molded feature(s) will be changed during vacuum forming such that the remaining molded feature(s) will have thicker walls, leading to a stiffer performance of an associated plastic part. For example, a thickness of molded feature A of the final plastic product 200 with use of the mold 250 will be a thickness T2, which is greater than a previous thickness T1 created by use of the mold 150 to form molded feature A in either of final plastic products 100, 200. The thicker molded feature A of FIG. 2A having the thickness T2 will have a corresponding increased rigidity and, thus, a stiffer performance with respect to an area surrounding molded feature A.

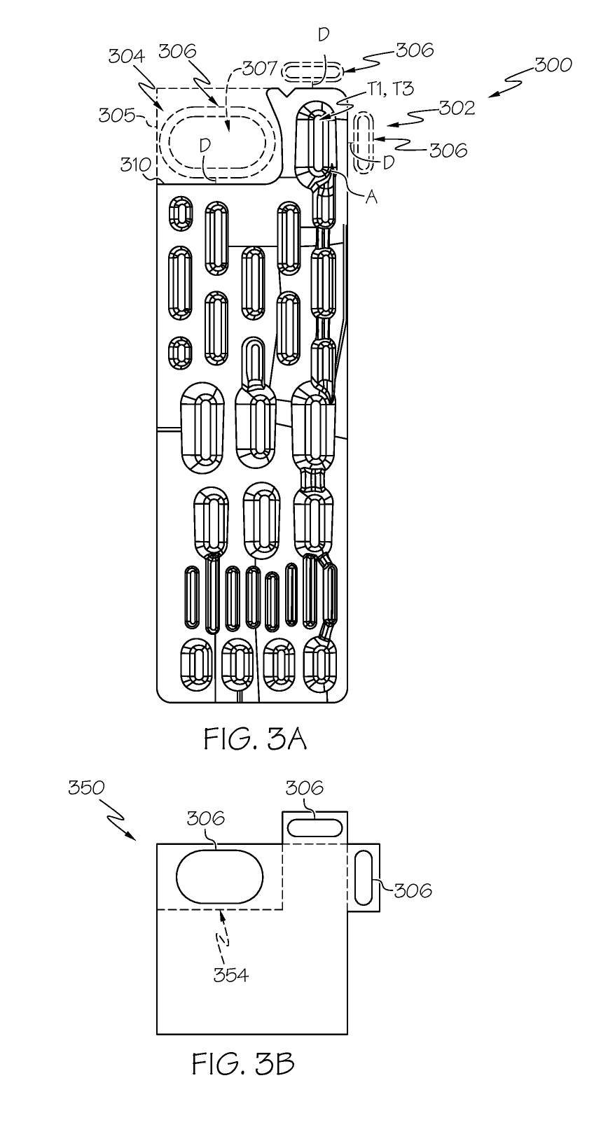

In an embodiment, a mold tool such as mold 350, as schematically illustrated in FIG. 3B, is designed with sacrificial forming features 306 (e.g., shapes) to form a preform plastic product 305 (FIG. 3A) from which to form the final plastic product 300 including a single molded feature A that has a thickness T1 (similar to the final plastic product 100 formed by the mold 150) or a thickness T3 (that may be substantially similar to the thickness T1). The sacrificial forming features 306 may each be individually removably attached to or integrally formed with the mold 350.

The sacrificial forming features 306, as shown in FIG. 3A, pull and stretch surrounding areas of the first input plastic material during the vacuum forming process and thus thin out the remaining molded feature(s) (such as molded feature A) to result in a similar condition for those molded feature(s) (e.g., molded feature A) as that which would result with use of the mold 150 of FIG. 1B. Thus, without changing an input plastic material thickness, the mold design with the mold 350 allows for a local thinning of EA safety plastic at selective areas to, for example, make a selective, locally thinned area around molded feature A of the preform plastic product 305 and a corresponding selective area of the final plastic product 300 less stiff than the area around molded feature A of the final plastic product 200. Thus, use of the mold 350 may achieve a performance target with respect to an associated final design having selective remaining features for the final plastic product 300 not otherwise achievable with the molds 150 or 250.

For example, the inline trimming operation requires a minimum distance D from a trimline 310 to the remaining molded feature(s) (e.g., molded feature A) that may not be met with mold 150 of FIG. 1B. In embodiments, the one or more sacrificial forming features 306 are disposed on the mold 350 within a notch area of the preform plastic product 305 (e.g., associated with a portion 304) and spaced a sufficient minimum distance D from the trimline 310 of the preform plastic product 305 to permit the inline trimming operation of the inline trimmable part of the portion 304. The portion 304 may be, for example, associated with the notch area from which to form a notch 307 defined by a footprint of the final plastic product 300 and disposed between and inward of outermost perimeter ends of the final plastic product 300. The minimum distance D may be, for example, about 3 mm to 5 mm.

Thus, the mold 350 can eliminate a need for a secondary offline trimming operation to remove molded features B and C by simplifying the shape of the notch area. Eliminating the secondary offline trimming process results in eliminating the associated additional cost and streamlining the operation to only use inline trimming in an application. As shown in FIGS. 3A-3B, the mold 350 includes sacrificial forming features 306 to form corresponding shapes of the input plastic material part to create the preform plastic product 305, which corresponding shapes will be trimmed to form the final plastic product 300 such that the shapes of the sacrificial forming features 306 are outside of a periphery of the final plastic product 300. For example, a portion 304 of the preform plastic product 305 that is associated with the shapes of the sacrificial forming features 306 and that forms a notch 307 of the final plastic product 300 may be trimmed off as scrap to form the final plastic product 300.

The shapes of the sacrificial forming features 306 may be a male shape such as a cone or another drawn shape that itself does not serve a function for the final performance of the final plastic product 300 (as an associated portion 304 of the plastic part may be trimmed off) but does affect the overall function of the final plastic product 300. The cone or other shapes may have flat or pointed top surfaces, be symmetric or asymmetric, and/or have varying heights across the shape. Such shapes (e.g., of sacrificial forming features 306) in the mold 350 may thus during vacuum forming create an area around the remaining molded feature A on the final plastic product 300 that is thinner than the area around the molded feature A would be without the use of the shapes (e.g., the sacrificial forming features 306) and that, thus, reduces an associated stiffness of the area of remaining molded feature A of the final plastic product 300.

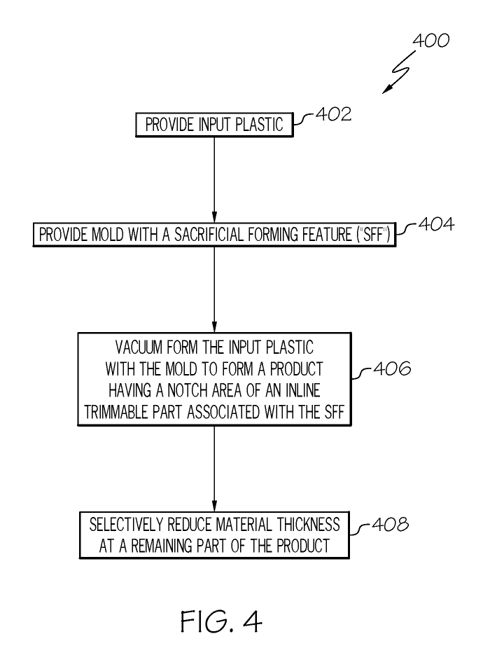

For example, as shown in FIG. 4, a method 400 for vacuum forming of the final plastic product 300 includes providing a first input plastic material in step 402. A mold such as the mold 350 for the preform plastic product 305 from which to form the final plastic product 300 is provided in step 404, the mold 350 having one or more sacrificial forming features 306 as described above that are associated with forming an inline trimmable part of the preform plastic product 305. For example, the inline trimmable part defines a notch area from which to form the notch 307 of the final plastic product 300 from the portion 304 of the preform plastic product 305. A sacrificial forming feature 306 is positioned on the mold 350 to be disposed in the notch area (e.g., the portion 304) of the preform plastic product 305. The sacrificial forming feature 306 may schematically represent a single sacrificial forming feature or multiple sacrificial forming features disposed in the notch area. The notch area of the inline trimmable part may be configured to be trimmed by an inline trimming operation to form the notch, for example. The one or more sacrificial forming features 306 are shaped to reduce a material thickness at selective remaining locations of the preform plastic product 305 that are associated with corresponding selective remaining locations of the final plastic product 300, such as at molded feature A.

The first input plastic material is disposed on the mold to form an assembly. In step 406, the assembly is subjected to vacuum forming to form the preform plastic product 305 that has an inline trimmable part (e.g., the portion 304) associated with the one or more sacrificial forming features 306. During and through the vacuum forming, as shown in step 408, material thickness at selective remaining locations of the preform plastic product 305 (such as at molded feature A) is selectively reduced to effect a corresponding localized stiffness reduction at the selective remaining locations and at corresponding selective remaining locations of the final plastic product. For example, a thinner wall results in a weaker, less rigid, and thus less stiff wall, while a thicker wall results in a more rigid, stiffer wall.

As described above, in embodiments, the final plastic product 300 is a vehicle impact absorption plate made of the first input plastic material, which is made of an EA safety plastic. The method 400 may further include inline trimming the inline trimmable part of the portion 304 of the preform plastic product 305 to result in the final plastic product 300 without the cost of an additional offline trimming process. The method 400 may also include cooling and solidifying processes to form the final plastic product 300.

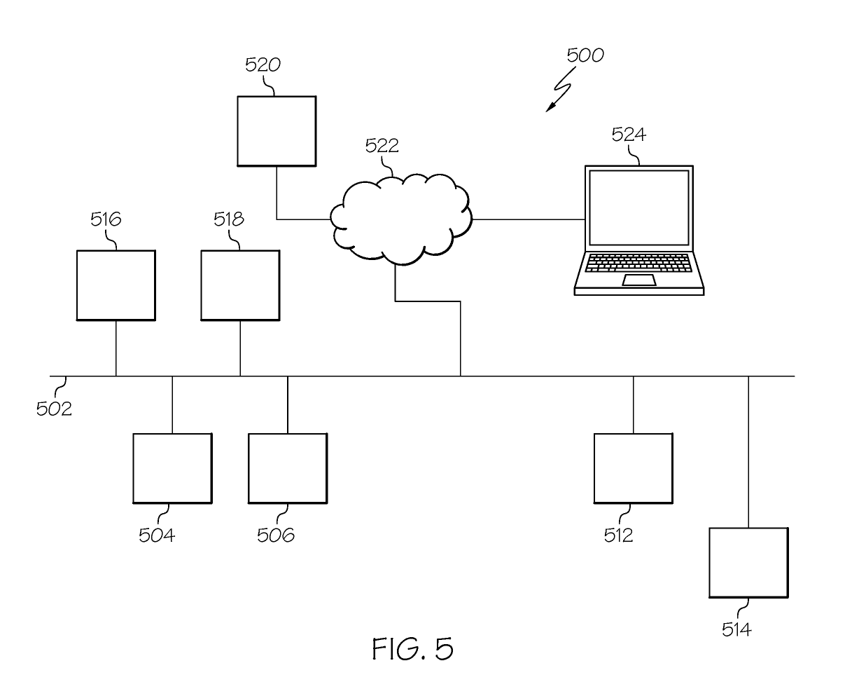

Referring to FIG. 5, a system 500 for implementing a computer and software-based method to utilize the vacuum forming process and mold tools, such as those shown in FIGS. 3A-4, is illustrated as being implemented along with using a GUI that is accessible at a user workstation (e.g., a computer 524), for example. The system 500 includes a communication path 502, one or more processors 504, a memory component 506, a trimming machinery 512, a storage or database 514, a vacuum forming machinery 516, a network interface hardware 518, a network 522, a server 520, and at least one computer 524. The various components of the system 500 and the interaction thereof will be described in detail below.

While only one application server 520 and one user workstation computer 524 is illustrated, the system 500 can include multiple workstations and application servers containing one or more applications that can be located at geographically diverse locations across a plurality of industrial sites. In some embodiments, the system 500 is implemented using a wide area network (WAN) or network 522, such as an intranet or the Internet. The workstation computer 524 may include digital systems and other devices permitting connection to and navigation of the network. Other system 500 variations allowing for communication between various geographically diverse components are possible. The lines depicted in FIG. 5 indicate communication rather than physical connections between the various components.

As noted above, the system 500 includes the communication path 502. The communication path 502 may be formed from any medium that is capable of transmitting a signal such as, for example, conductive wires, conductive traces, optical waveguides, or the like, or from a combination of mediums capable of transmitting signals. The communication path 502 communicatively couples the various components of the system 500. As used herein, the term “communicatively coupled” means that coupled components are capable of exchanging data signals with one another such as, for example, electrical signals via conductive medium, electromagnetic signals via air, optical signals via optical waveguides, and the like.

As noted above, the system 500 includes the processor 504. The processor 504 can be any device capable of executing machine readable instructions. Accordingly, the processor 504 may be a controller, an integrated circuit, a microchip, a computer, or any other computing device. The processor 504 is communicatively coupled to the other components of the system 500 by the communication path 502. Accordingly, the communication path 502 may communicatively couple any number of processors with one another, and allow the modules coupled to the communication path 502 to operate in a distributed computing environment. Specifically, each of the modules can operate as a node that may send and/or receive data.

As noted above, the system 500 includes the memory component 506 which is coupled to the communication path 502 and communicatively coupled to the processor 504. The memory component 506 may be a non-transitory computer readable medium or non-transitory computer readable memory and may be configured as a nonvolatile computer readable medium. The memory component 506 may comprise RAM, ROM, flash memories, hard drives, or any device capable of storing machine readable instructions such that the machine readable instructions can be accessed and executed by the processor 504. The machine readable instructions may comprise logic or algorithm(s) written in any programming language such as, for example, machine language that may be directly executed by the processor, or assembly language, object-oriented programming (OOP), scripting languages, microcode, etc., that may be compiled or assembled into machine readable instructions and stored on the memory component 506. Alternatively, the machine readable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components.

Still referring to FIG. 5, as noted above, the system 500 comprises the display such as a GUI on a screen of the computer 524 for providing visual output such as, for example, information, graphical reports, messages, or a combination thereof. The display on the screen of the computer 524 is coupled to the communication path 502 and communicatively coupled to the processor 504. Accordingly, the communication path 502 communicatively couples the display to other modules of the system 500. The display can include any medium capable of transmitting an optical output such as, for example, a cathode ray tube, light emitting diodes, a liquid crystal display, a plasma display, or the like. Additionally, it is noted that the display or the computer 524 can include at least one of the processor 504 and the memory component 506. While the system 500 is illustrated as a single, integrated system in FIG. 5, in other embodiments, the systems can be independent systems.

The system 500 comprises the vacuum forming machinery 516 for applying a vacuum process to form a preform plastic product from which to form a final plastic product as described herein. A first input plastic material having a restricted thickness (while over or prior to being disposed over a mold, such as the mold 350, within the vacuum forming machinery 516) is heated to a vacuum forming temperature to be pliable and moldable. The processor 504 may instruct the vacuum forming machinery 516 to apply the vacuum forming process as described above. The vacuum forming machinery 516 may transmit signals relating to status of the heating and/or vacuum forming processes to the processor 504. The processor 504 may utilize the trimming machinery 512 to trim/cut the vacuum formed product. The vacuum forming machinery 516 and the trimming machinery 512 are coupled to the communication path 502 and communicatively coupled to the processor 504. As will be described in further detail below, the processor 504 may process the input signals received from the system modules and/or extract information from such signals. For example, in embodiments, the processor 504 may execute instructions after receiving a completed status of the vacuum forming process to automatically initiate an inline trim operation with the trimming machinery 512 to trim an inline trimmable part of a plastic product after vacuum forming such as the preform plastic product 305 so to result in the final plastic product 300.

The system 500 includes the network interface hardware 518 for communicatively coupling the system 500 with a computer network such as network 522. The network interface hardware 518 is coupled to the communication path 502 such that the communication path 502 communicatively couples the network interface hardware 518 to other modules of the system 500. The network interface hardware 518 can be any device capable of transmitting and/or receiving data via a wireless network. Accordingly, the network interface hardware 518 can include a communication transceiver for sending and/or receiving data according to any wireless communication standard. For example, the network interface hardware 518 can include a chipset (e.g., antenna, processors, machine readable instructions, etc.) to communicate over wired and/or wireless computer networks such as, for example, wireless fidelity (Wi-Fi), WiMax, Bluetooth, IrDA, Wireless USB, Z-Wave, ZigBee, or the like.

Still referring to FIG. 5, data from various applications running on computer 524 can be provided from the computer 524 to the system 500 via the network interface hardware 518. The computer 524 can be any device having hardware (e.g., chipsets, processors, memory, etc.) for communicatively coupling with the network interface hardware 518 and a network 522. Specifically, the computer 524 can include an input device having an antenna for communicating over one or more of the wireless computer networks described above.

The network 522 can include any wired and/or wireless network such as, for example, wide area networks, metropolitan area networks, the Internet, an Intranet, satellite networks, or the like. Accordingly, the network 522 can be utilized as a wireless access point by the computer 524 to access one or more servers (e.g., a server 520). The server 520 and any additional servers generally include processors, memory, and chipset for delivering resources via the network 522. Resources can include providing, for example, processing, storage, software, and information from the server 520 to the system 500 via the network 522. Additionally, it is noted that the server 520 and any additional servers can share resources with one another over the network 522 such as, for example, via the wired portion of the network, the wireless portion of the network, or combinations thereof.

In embodiments, the vacuum forming methods described herein include one or more molds having one or more sacrificial forming features associated with a part of the respective preform plastic product to be trimmed via an inline trimming operation to form a final plastic product. The sacrificial forming features may be spaced a sufficient minimum distance from a trimline to permit the inline trimming operation, and the sacrificial forming features are shaped to selectively reduce material thickness and associated stiffness of one or more remaining molded features of the final plastic product.

It is noted that the terms “substantially” and “about” and “approximately” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method for vacuum forming to form a final plastic product that has a notch disposed between and inward of outermost perimeter ends of the final plastic product, the method comprising:
providing a first input plastic material;
providing a mold for a preform plastic product from which to form the final plastic product, wherein:
the mold has a sacrificial forming feature associated with forming an inline trimmable part of the preform plastic product, the inline trimmable part defining a notch area from which to form the notch of the final plastic product, the sacrificial forming feature positioned on the mold to be disposed within the notch area,
the notch area of the inline trimmable part is configured to be trimmed via an inline trimming operation to form the notch, and
the sacrificial forming feature is shaped to selectively reduce a material thickness at a selective remaining location of the preform plastic product;
disposing the first input plastic material on the mold to form an assembly;
applying vacuum forming to the assembly to form the preform plastic product; and
reducing the material thickness the selective remaining location of the preform plastic product during vacuum forming to affect a localized stiffness reduction at a corresponding selective remaining location of the final plastic product.

2. The method of claim 1, wherein the final plastic product comprises a vehicle impact absorption plate.

3. The method of claim 2, wherein the vehicle impact absorption plate is made of the first input plastic material comprising an energy absorption (EA) safety plastic.

4. The method of claim 1, wherein the sacrificial forming feature is disposed on the mold and spaced a sufficient minimum distance from a trimline of the preform plastic product to permit the inline trimming operation of the inline trimmable part.

5. The method of claim 1, wherein the sacrificial forming feature comprises a cone shape.

6. The method of claim 1, wherein the selective remaining location of the preform plastic product comprises a cone shape.

7. The method of claim 1, further comprising inline trimming the inline trimmable part.

8. The method of claim 1, wherein the sacrificial forming feature comprises one of a single sacrificial forming feature and multiple sacrificial forming features.

9. A mold for vacuum forming to form a final plastic product that has a notch disposed between and inward of outermost perimeter ends of the final plastic product, the mold comprising:
a sacrificial forming feature associated with forming an inline trimmable part of a preform plastic product from which to form the final plastic product, the inline trimmable part defining a notch area from which to form the notch of the final plastic product, the sacrificial forming feature positioned on the mold to be disposed within the notch area, wherein:
the notch area of the inline trimmable part is configured to be trimmed via an inline trimming operation to form the notch, and
the sacrificial forming feature is shaped to selectively reduce a material thickness at a selective remaining location of the preform plastic product that is configured to form a corresponding selective remaining location of the final plastic product.

10. The mold of claim 9, wherein the final plastic product comprises a vehicle impact absorption plate.

11. The mold of claim 10, wherein the vehicle impact absorption plate is made of a first input plastic material comprising an energy absorption (EA) safety plastic.

12. The mold of claim 9, wherein the sacrificial forming feature is disposed on the mold and spaced a sufficient minimum distance from a trimline of the preform plastic product to permit the inline trimming operation of the inline trimmable part.

13. The mold of claim 9, wherein the sacrificial forming feature comprises a cone shape.

14. The mold of claim 9, wherein the corresponding selective remaining location of the final plastic product comprises a cone shape.

15. A system for vacuum forming to form a preform plastic product from which to form a final plastic product that has a notch disposed between and inward of outermost perimeter ends of the final plastic product, the system comprising:
a processor communicatively coupled to a non-transitory computer storage medium, wherein the non-transitory computer storage medium stores instructions that, when executed by the processor, cause the processor to:
heat a first input plastic material to an optimal vacuum forming temperature such that the first input plastic material becomes pliable;
automatically position the pliable first input plastic material on a mold for the final plastic product to form an assembly, wherein the mold comprises:
a sacrificial forming feature associated with forming an inline trimmable part of the preform plastic product, the inline trimmable part defining a notch area from which to form the notch of the final plastic product, the sacrificial forming feature positioned on the mold to be disposed within the notch area, wherein:
the notch area of the inline trimmable part is configured to be trimmed via an inline trimming operation to form the notch, and
the sacrificial forming feature is shaped to selectively reduce a material thickness at a selective remaining location of the preform plastic product; and
apply a vacuum forming process to the assembly to form the preform plastic product such that the material thickness at the selective remaining location of the preform plastic product is reduced during vacuum forming to affect a localized stiffness reduction at a corresponding selective remaining location of the final plastic product.

16. The system of claim 15, wherein the final plastic product comprises a vehicle impact absorption plate made of the first input plastic material comprising an energy absorption (EA) safety plastic.

17. The system of claim 15, wherein the sacrificial forming feature is disposed on the mold and spaced a sufficient minimum distance from a trimline of the preform plastic product to permit the inline trimming operation of the inline trimmable part.

18. The system of claim 15, further comprising instructions that, when executed by the processor, cause the processor to:
automatically initiate an inline trim operation to trim the inline trimmable part.

19. The system of claim 15, further comprising instructions that, when executed by the processor, cause the processor to:
cool and solidify the preform plastic product.

20. The system of claim 15, wherein the corresponding selective remaining location of the final plastic product comprises a cone shape.
